(19) United States
(12) Patent Application Publication
(10) Pub. No.: US 2014/0344120 A1
(43) Pub. Date: Nov. 20, 2014

(54) PAY CODE CONFIGURATION

(71) Applicant: TATA CONSULTANCY SERVICES LIMITED, Mumbai (IN)

(72) Inventors: Viral Prakash Shah, Vikhroli (W) (IN); Siva Reddy, Vikhroli (W) (IN); Jay Hemendrakumar Shah, Vikhroli (W) (IN); Siddhesh Tukaram Ghadigaonkar, Vikhroli (W) (IN)

(73) Assignee: TATA CONSULTANCY SERVICES LIMITED, Mumbai (IN)

(21) Appl. No.: 14/281,215

(22) Filed: May 19, 2014

(30) Foreign Application Priority Data
May 17, 2013 (IN) 1770/MUM/2013

(51) Int. Cl. G06Q 40/00

(52) U.S. Cl. CPC G06Q 40/125
USPC 705/32

(57) ABSTRACT

A method for pay code configuration comprises obtaining one or more pay code parameters and one or more eligibility parameters by a processor. The eligibility parameters indicate eligibility criteria for an employee to be eligible for remunerations corresponding to a particular pay code as a part of the employee's net pay. The pay code parameters are used for computing the remuneration corresponding to the particular pay code. An eligibility rule is generated by the processor based on the eligibility parameters for determining whether the employee is eligible for the remunerations corresponding to the particular pay code. Further, a pay code calculation formula is defined by the processor based on the one or more pay code parameters for calculating the remuneration. Furthermore, the eligibility rule and the pay code calculation formula are mapped to a payroll system of an organization by the processor for configuring the pay code.

### TECHNICAL FIELD

The present subject matter relates to payroll processing and, particularly but not exclusively, to pay code configuration.

### BACKGROUND

Payroll processing is used by an employer or a concerned department, such as accounts department or human resource department, of an organization to determine and distribute remunerations to an employee. Payroll processing is typically a periodic process, for example, occurring monthly or bi-monthly, and involves determining various remuneration components, such as salary, overtime, bonuses, employer's contribution to pension schemes or provident fund, and various other allowances. The remuneration components, also known as pay codes, may vary across different organizations based on various factors, such as a remuneration structure; organization type, such as public sector and private sector; organization's business sector, such as banking, software, consulting, and legal. Further, the eligibility for remunerations under various pay codes may vary across different employees within an organization based on various factors, such as designation, department, and working hours.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a pay code configurator, in accordance with an embodiment of the present subject matter.

FIG. 2 illustrates a method for pay code configuration, in accordance with an embodiment of the present subject matter.

### DETAILED DESCRIPTION

Systems and methods for pay code configuration are described herein. Pay codes may be understood as various payheads under which remunerations of an employee are categorized to determine a net pay to be provided to the employee at the end of a pay-cycle. The net pay is typically calculated by an accounts department and/or human resource department (HRD) of an organization at the end of the pay-cycle using a payroll process. The payroll process typically involves determining remuneration for various pay codes, such as salary, overtime, bonuses, employer's contribution to pension schemes or provident fund, and various allowances to which the employee is entitled. Being a tedious and complex process, the payroll process is typically carried out by organizations using automated payroll systems.

Generally, payroll systems automatically determine remunerations corresponding to each pay code using a pay code calculator. Being dependent on various factors, such as eligibility for remunerations and amount of remuneration, the pay code calculators generally vary across organizations and are thus customized for each organization before being implemented in the corresponding payroll systems. Typically, techniques for configuring the pay code calculator include obtaining the pay code requirements from the organization and manually creating software codes as per the pay code calculator for the organization. The software codes for each pay code are subsequently implemented in the payroll system.

Further, since the pay codes may vary across different organizations based on various factors, such as a remuneration structure, organization type, and organization's business sector, the payroll systems too may vary for the organizations. The developers may thus either create completely separate payroll systems for each organization or various software codes for integration with the existing payroll system as variations in the pay codes may lead to substantial variations in the payroll system. Creating the software code calculators for each organization individually and configuring them on the corresponding payroll systems, however, is a tedious and time consuming process as developers have to create each software code from scratch. This would further involve determining and integrating one or more operational parameters associated with the computing system functioning as payroll systems. As would also be appreciated, if such considerations are not heeded, resulting systems would not operate or function in the desired manner, or might function in an unexpected manner.

Further, owing to the time required for creating the software codes for new pay code calculators, the organizations may not be able to immediately implement any new policy changes in the pay codes. Furthermore, due to any modification in the pay code, for example, due to modification in policies, the developers may have to create completely new pay code calculators, thus increasing the implementation cost and time of the payroll systems.

The present subject matter describes methods and systems for pay code configuration. According to an embodiment of the present subject matter, a pay code configurator is provided to facilitate efficient pay code configuration for the payroll systems. The pay code configurator may initially obtain one or more pay code parameters and eligibility parameters for defining pay code calculation formula and eligibility parameters, respectively, corresponding to a pay code that an organization may intend to implement in its payroll system. Although, the present subject matter has been described with reference to one pay code, it would be understood that the pay code configurator can be used to configure various pay codes.

The eligibility parameters may be understood as the parameters that indicate an eligibility criterion for employees to avail remunerations under a given pay code as a part of their net pay. Further, the pay code parameters may be understood as the parameters that may be used in computing the remunerations for the corresponding pay code. In one implementation, the pay code parameters and the eligibility parameters may be determined based on pay code requirements provided by the organization. In another implementation, the pay code parameters and the eligibility parameters may be directly provided by the organization.

Upon determination, the pay code configurator may analyze the parameters and their sub-parameters to define the pay code calculation formula and the eligibility parameters corresponding to the pay code. In one implementation, the pay code configurator may generate the eligibility rule to determine whether the employee is eligible for the remuneration and a part of the net pay in which the pay code has to be included. For instance, the eligibility rule may define that the remunerations will be available to all employees as a part of the cost to company (CTC) component of their net pay.

The pay code configurator may subsequently define the pay code calculation formula based on the pay code parameters. The pay code calculation formula may define a relationship between the pay code parameters using mathematical operators such that a user, such as an HR Manager and an accountant of the organization may calculate the remuneration corresponding to the pay code by providing values to the various pay code parameters used in the pay code calculation formula. The pay code calculation formula and the eligibility rule may thus be integrated to configure the pay code. In one implementation, the pay code calculation formula and the eligibility rule thus created may be mapped to the payroll system of the organization for configuring the pay code that may be executed while processing net pay of the user. For instance, at the end of a pay cycle the user may login to the payroll system using the organization's login credentials to execute the various pay codes for calculating the net pay of the employee.

The system for evaluating payroll based on parameters, such as the eligibility parameters and the pay code parameters facilitates easy and fast generation of the eligibility rules and pay code calculation formula as the pay code configurator may configure the pay code in the payroll system by defining relation between these parameters without requiring a manual intervention of creating algorithms for configuring the pay code. Further, in case of any policy change in the organization, the pay code may be easily modified by providing the modification requirements to the pay code configurator for modifying the eligibility rule and/or the pay code calculation formula, thus eliminating the need of creating completely new software codes. The present subject matter thus provides systems and methods for efficient pay code configuration.

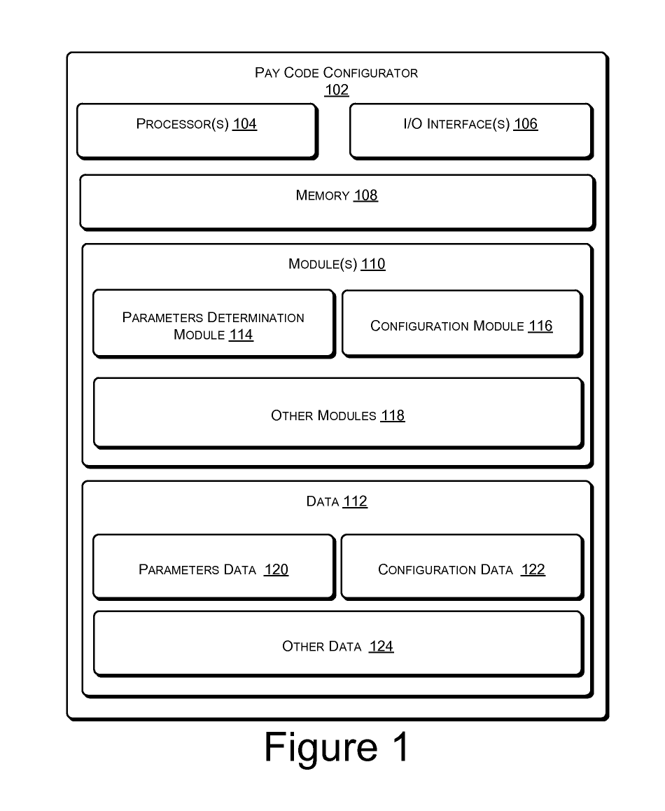

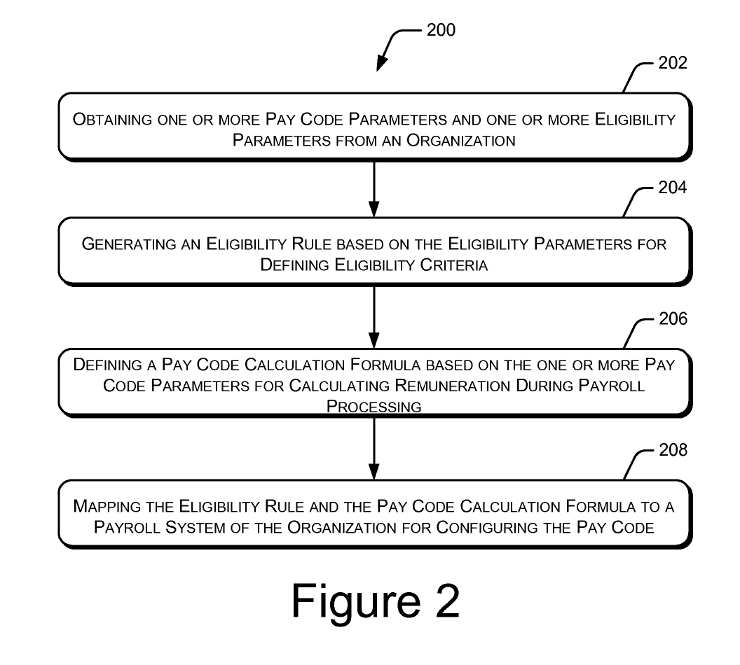

The manner in which the systems and the methods for pay code configuration are implemented is explained in detail with respect to FIGS. 1 and 2. While aspects of described systems and methods for pay code configuration can be implemented in any number of different computing systems, environments, and/or configurations, the embodiments are described in the context of the following system(s).

FIG. 1 illustrates a schematic view of a pay code configurator 102, according to an implementation of the present subject matter. The pay code configurator 102 may be associated with a payroll system (not shown in the figure) of an organization to configure pay codes for being used by the payroll system. The pay code configurator 102 may be implemented in a variety of computing devices, including, a server, a desktop computer, a notebook or portable computer, a multiprocessor system, a workstation, a network computer, cloud servers, minicomputers, a mainframe computer, and a laptop. In one implementation, the pay code configurator 102 may be implemented in the same server that is hosting the payroll system.

According to an embodiment of the present subject matter, the pay code configurator 102 includes processor(s) 104, I/O interface(s) 106, and a memory 108 coupled to the processor(s) 104. The I/O interface(s) 106 may include a variety of software and hardware interfaces, for example, interfaces for peripheral device(s), such as a keyboard, a mouse, an external memory, and a printer. Further, the I/O interface(s) 106 may enable the pay code configurator 102 to communicate with other devices, such as web servers and external databases. The I/O interface(s) 106 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface(s) 106 may include one or more ports for connecting a number of computing systems with each other or to another server computer.

The processor(s) 104 can be a single processing unit or a number of units, all of which could include multiple computing units. The processor 104 may be implemented as one or more microprocessors, microcomputers, microcontrollers, digital signal processors, data processing units, state machines, logic circuitries, and/or any devices that manipulate signals based on operational instructions. Among other capabilities, the processor 104 is configured to fetch and execute computer-readable instructions and data stored in the memory 108.

The memory 108 may include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In one implementation, the pay code configurator 102 also includes module(s) 110 and data 112.

The module(s) 110, amongst other things, include routines, programs, objects, components, data structures, etc., which perform particular tasks or implement data types. The module(s) 110 may also be implemented as, signal processor(s), state machine(s), logic circuitries, and/or any other device or component that manipulate signals based on operational instructions.

Further, the module(s) 110 can be implemented in hardware, instructions executed by a processing unit, or by a combination thereof. The processing unit can comprise a computer, a processor, such as the processor 104, a state machine, a logic array or any other suitable devices capable of processing instructions. The processing unit can be a general-purpose processor which executes instructions to cause the general-purpose processor to perform the required tasks or, the processing unit can be dedicated to perform the required functions.

In another aspect of the present subject matter, the module(s) 110 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

In one implementation, the module(s) 110 further include a parameters determination module 114, a configuration module 116, and other module(s) 118. The other module(s) 118 may include programs or coded instructions that supplement applications and functions of the pay code configurator 102. The data 112 serves, amongst other things, as a repository for storing data processed, received, and generated by one or more of the module(s) 110. The data 112 includes parameters data 120, configuration data 122, and other data 124. The other data 124 includes data generated as a result of the execution of one or more modules in the module(s) 110.

As previously described, the pay code configurator 102 may be associated with the payroll system to configure pay codes for the payroll system based on the requirements of the organization implementing the payroll system. For instance, an organization, say, a manufacturing unit may introduce a policy of providing remunerations for overtime hours to all employees in labor category. In order to implement the policy, the organization may introduce a new pay code “overtime hours” and send a configuration request to the pay code configurator 102 for configuring and implementing the pay code in the payroll system. Upon receiving the configuration request, the parameters determination module 114 may obtain one or more pay code parameters and one or more eligibility parameters based on the configuration request. The eligibility parameters define an eligibility criterion for employees to avail remunerations under the pay code as a part of their net pay. The pay code parameters are the parameters used in defining a pay code formula for calculating the remunerations. For instance, in order to generate rules for configuring the pay code overtime hours, the parameters determination module 114 may determine “employee grade” as eligibility parameter. Further, the parameters determination module 114 may determine sum of eligible pay codes, number of days in a month, number of hours in a day, and number of overtime hours as the pay code parameters.

In one implementation, the parameters determination module 114 may obtain the pay code parameters and the eligibility parameters by analyzing pay code requirements provided in the configuration request by the organization. In said implementation, the pay code parameter may include a simple requirement like “Overtime should be calculated on sum of basic and dearness allowance (DA) on hourly basis at double rate”. The parameters determination module 114 in such a case may analyze the pay code requirement and determine the eligibility parameters and the pay code parameters, hereinafter collectively referred to as parameters. For instance, the parameters determination module 114 may determine the parameters using parameters previously used to meet such a similar requirement of any other organization. For instance, the parameters determination module 114 may access the parameters data 120 to obtain the parameters used for configuring pay code for overtime hours for another manufacturing organization or for another class of employees of the same organization. The parameters determination module 114 may subsequently modify the parameters based on the pay code requirements of the organization in order to customize the pay code rules for the corresponding pay code. Further, in order to analyze the pay code requirements, the parameters determination module 114 may parse the pay code requirements in case of the pay code parameters being a string. Similarly, in case of the pay code requirements being in a tabular form, the parameters determination module 114 may analyze the pay code requirements by determining relationship between data provided in different columns and rows.

In another implementation, the parameters may be provided by the organization as a part of the pay code requirements. The parameters determination module 114 in such a case may use the parameters for generating the pay code rules.

Further, the parameters determination module 114 may save the parameters in the parameters data 120. The parameters determination module 114 may further ascertain sub-parameters for each of the parameters. The sub-parameters help in defining a parameter and its functionalities for generating the pay code rule. Examples of sub-parameters include parameter type, parameter name, query, field type for parameter value, and list of values (LOV) query. Parameter type indicates whether the parameter is an eligibility parameter or a pay code parameter. For instance, in the previous example of overtime hours, the parameter type corresponding to employee grade will be eligibility parameter, while the parameter type corresponding to sum of eligible pay codes will be pay code parameter.

The parameters query may be a code, such as a sql statement associated with the parameter to extract values corresponding to the parameter from a database associated with the payroll system upon execution of the pay code rule in the payroll system. In one implementation, the query may be saved in a database associated with the payroll system and obtained based on the parameter. For instance, while calculating net pay for an employee A, the query corresponding to the eligibility parameter employee grade may obtain the grade for the employee A based on which the payroll system may determine whether or not the employee is eligible for the pay code overtime hours. Field type for parameter value may define the data type, such as integer, char, and string of value for each parameter and the data type of field for entering the value. The LOV query may be a code, similar to the query, and associated with the parameter to extract values corresponding to the parameter in LOV format when the data type for the field type is LOV. In one implementation, the LOV format may be used to provide values for the parameters having large number of values. For instances, since number of employees in an organization may always keep on changing from time to time and may vary from hundred to thousand number of values due to which the values of a parameter “employee number” may be kept in LOV format. Thus, while selecting employees eligible for bonus, the user of the payroll system may be provided the employee numbers in the LOV format, showing the employee number of all the employees in the form of a list, from which the user may select the employee numbers of the employees eligible for the bonus.

Upon determination of the parameters, the configuration module 116 may analyze the parameters and their sub-parameters to configure the pay code. For the purpose, the rule configuration module 116 may initially generate an eligibility rule and a pay code calculation formula. The eligibility rule may be understood as a rule that defines the eligibility criteria for the employees and the part of the net pay in which the pay code has to be included. For instance, in the above example of overtime hours, the eligibility rule may define that the remunerations will be available as a part of the cost to company (CTC) component of net pay for all employees in the labor category. In order to generate the eligibility rule, the configuration module 116 may determine values of various rule sub-components required for the generation. Examples of the rule sub-components include, but are not limited to, pay code name, pay code output, eligibility parameter, mathematical operators, and parameter value.

Pay code name may define the pay code for which the eligibility rule is created, for example, overtime hours. Pay code output define the part of the net pay in which the pay code has to be included, for example, whether the remuneration will be a part of CTC or outside CTC. Mathematical parameters may be the generally known mathematical operators, such as =, <, >, NOT, AND, and OR used for defining relation between different parameters while generating the eligibility rule. Parameter value defines the value of the eligibility parameter. For example, in case of employee grade as the eligibility parameter, the parameter value may be labor class. In one implementation, the configuration module 116 may determine the values of the rule sub-components based on user inputs received from a user of the pay code configurator 102, such as a developer and an administrator. For the purpose, the configuration module 116 may provide a rule configuration table on a display screen (not shown in the figure) associated with the pay code configurator 102 using which the user may provide the values for the rule sub-components in designated fields corresponding to the rule sub-components provided in the rule configuration table.

Upon determining the values of the rule sub-components, the configuration module 116 may generate the eligibility rule and assign it a name based on a pay code ID corresponding to the pay code name. For instance, in the above example of overtime hours, the configuration module 116 may generate an eligibility rule “pay code ID_R1” that will be applicable to all labor category employees as a part of their CTC. The configuration module 116 may subsequently save the eligibility rule in the configuration data 122. In one implementation, the configuration module 116 may generate the eligibility rule based on the values of the rule sub-components, the pay code parameters, and user inputs. For instance, a user of the pay code configurator 102 may define, using the I/O interfaces 106, the relationship between the different sub-components and the pay code parameters for generating the parameter. In another implementation, the configuration module 116 may determine the relationship between the different sub-components and the pay code parameters based on the values of the rule sub-components to generate the eligibility rule.

The configuration module 116 may further define a pay code calculation formula for calculating remuneration corresponding to the pay code. The pay code calculation formula may be used by the payroll system for calculating the remuneration by obtaining values to the various code parameters used in the pay code calculation formula. In order to define the pay code calculation formula, the configuration module 116 may determine relationship between the various pay code parameters using one or more formula sub-components. Examples of the formula sub-components include, but are not limited to, priority, calculation function, mathematical operators, and parameter value.

Priority may define the time or sequence of execution of the pay code calculation formula, for example, whether it should be executed before or after any particular event or formula. Mathematical parameters may be the generally known mathematical operators, such as =, <, >, NOT, AND, and OR used for defining relation between different parameters while defining the pay code calculation formula. Parameter value defines the value of the code parameter. For example, in case of sum of eligible pay codes as the pay code calculation formula, the parameter value may be the gross income of the employee. In one implementation, values of one or more pay code parameters may not be determined by the configuration module 116 and be dynamically determined by the payroll system while processing the pay code. Calculation function may be preconfigured functions, such as round-off and absolute that may be associated with the pay code calculation formula.

In one implementation, the configuration module 116 may determine the relationship between the pay code parameters using the rule sub-components based on user inputs received from a user of the pay code configurator 102, such as a developer and an administrator. For the purpose, the configuration module 116 may provide a formula configuration table on the display screen associated with the pay code configurator 102 using which the user may provide the inputs, such as the mathematical operators and the calculation formula for defining the relationship in designated fields corresponding to the rule sub-components provided in the formula configuration table.

Upon determining the relationship between the pay code parameters, the configuration module 116 may define the pay code calculation formula and associate it with the eligibility rule. For instance, in the above example of overtime hours, the configuration module 116 may define the pay code calculation formula and associate it with the eligibility rule such that the pay code calculation formula can be executed to determine the remunerations whenever the eligibility criteria set by the eligibility rule is met. Further, the configuration module 116 may save the pay code calculation formula in the configuration data 122.

The configuration module 116 may further map the pay code calculation formula and the eligibility rule to the payroll system for configuring the pay code such that during payroll processing the payroll system may execute the eligibility rule and the pay code calculation formula for determining remunerations for the corresponding pay code. For instance, at the end of a pay cycle the user may login to the payroll system using the organization's login credentials to execute the various pay codes for calculating the net pay of the employee.

FIG. 2 illustrates a method 200 for pay code configuration, in accordance with an implementation of the present subject matter. The method 200 is implemented in computing device, such as the pay code configurator 102. The method may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network.

The order in which the method is described is not intended to be construed as a limitation, and any number of the described method blocks can be combined in any suitable order to implement the method, or an alternative method. Additionally, individual blocks may be suitably deleted from the method without departing from the spirit and scope of the subject matter described herein. Furthermore, the method can be implemented in any suitable hardware, software, firmware, or combination thereof.

At block 202, one or more pay code parameters and one or more eligibility parameters are obtained. For instance, a pay code configurator, such as the pay code configurator 102 may obtain the pay code parameters and the eligibility parameters, hereinafter referred to as the parameters, from an organization that may wish to implement a new pay code or modify an existing pay code in its payroll system. The eligibility parameters may be understood as the parameters that indicate eligibility criteria for an employee to be eligible for remunerations corresponding to the pay code as a part of the employee's net pay. The pay code parameters are the parameters used in defining a pay code formula for calculating the remunerations. In one implementation, the pay code configurator may obtain the parameters by analyzing pay code requirements provided in a configuration request by the organization. In another implementation, the parameters may be provided by the organization as a part of the pay code requirements. Further, one or more sub-parameters, for example, a parameter type, a parameter name, a query, a parameter value field type, and an LOV query may be determined.

At block 204, an eligibility rule is generated based on the eligibility parameters for defining the eligibility criteria. The eligibility rule may be understood as a rule that defines the eligibility criteria for the employees and the part of the net pay in which the pay code has to be included. In one example, the pay code configurator 102 may generate the eligibility rule based on one or more rule sub-components, for example, pay code name, pay code output, eligibility parameter, mathematical operators, and parameter value. The eligibility rule thus generated may be stored in configuration data, such as the configuration data 122.

At block 206, a pay code calculation formula is defined based on the pay code parameters for calculating the remuneration during payroll processing. In one implementation, the pay code configurator may define the pay code calculation formula based one the pay code parameters and one or more formula sub-components. Examples of the formula sub-components include, but are not limited to, priority, calculation function, mathematical operators, and parameter value. Further, the pay code configurator may determine relationship between the various pay code parameters using one or more formula sub-components using user inputs to define the pay code calculation formula. The pay code calculation formula thus generated may be stored in configuration data, such as the configuration data 122.

At block 208, the eligibility rule and the pay code calculation formula are mapped to a payroll system of the organization for configuring the pay code. In one implementation, the pay code configurator 102 may associate the pay code calculation formula with the eligibility rule before mapping them to the payroll system of the organization.

Although embodiments for pay code configuration have been described in language specific to structural features and/or methods, it is to be understood that the subject matter is not necessarily limited to the specific features or methods described. Rather, the specific features and methods are disclosed as exemplary embodiments for pay code configuration.

I/We claim:

1. A computer implemented method for pay code configuration, the method comprising:
obtaining, by a parameters determination module, one or more pay code parameters and one or more eligibility parameters, wherein the eligibility parameters indicate eligibility criteria for an employee to be eligible for remuneration corresponding to a particular pay code, as a part of the employee's net pay, and wherein the pay code parameters are used for computing the remuneration corresponding to the particular pay code for the employee;
generating, by a processor, an eligibility rule based on the eligibility parameters, wherein the eligibility rule are used for determining whether the employee is eligible for the remuneration corresponding to the particular pay code;
defining, by the processor, a pay code calculation formula based on the one or more pay code parameters, wherein the pay code calculation formula is used for calculating the remuneration; and
mapping, by a configuration module, the eligibility rule and the pay code calculation formula to a payroll system of an organization for configuring the particular pay code, wherein the eligibility rule and the pay code calculation formula are used by the payroll system for determining eligibility and remunerations of the employee for the particular pay code.

2. The method as claimed in claim 1, wherein the method further comprises determining, by the parameters determination module, sub-parameters corresponding to the one or more pay code parameters, wherein the sub-parameters include at least one of a parameter type, a parameter name, a query, a parameter value field type, and an LOV query.

3. The method as claimed in claim 1, wherein the generating comprises determining, by the configuration module, values of one or more rule sub-components, and wherein the one or more rule sub-components include at least one of a pay code name, a pay code output, eligibility parameter, a mathematical operator, and a parameter value.

4. The method as claimed in claim 1, wherein the defining comprises determining, by the configuration module, relationship between the pay code parameters using one or more formula sub-components, and wherein the one or more formula sub-components include at least one of a priority, a calculation function, a mathematical operator, and a parameter value.

5. The method as claimed in claim 1, wherein the mapping further comprises associating, by the configuration module, the pay code calculation formula with the eligibility rule for configuring the pay code.

6. A pay code configurator comprising:
a processor;
a parameters determination module coupled to the processor to:
obtain one or more pay code parameters and one or more eligibility parameters from an organization, wherein the eligibility parameters indicate eligibility criteria for an employee to be eligible for remuneration corresponding to a particular pay code, as a part of the employee's net pay, and wherein the pay code parameters are used for computing the remuneration corresponding to the particular pay code for the employee; and
a configuration module coupled to the processor to:
generate an eligibility rule based on the eligibility parameters for determining whether the employee is eligible for the remuneration corresponding to the particular pay code;
define a pay code calculation formula based on the one or more pay code parameters for calculating the remuneration; and
map the eligibility rule and the pay code calculation formula to a payroll system of the organization for configuring the pay code.

7. The pay code configurator as claimed in claim 6, wherein the parameters determination module further determines, sub-parameters corresponding to the one or more pay code parameters, wherein the sub-parameters include at least one of a parameter type, a parameter name, a query, a parameter value field type, and an LOV query.

8. The pay code configurator as claimed in claim 6, wherein the configuration module further determines values of one or more rule sub-components, and wherein the rule sub-components include at least one of a pay code name, a pay code output, an eligibility parameter, a mathematical operator, and a parameter value.

9. The pay code configurator as claimed in claim 6, wherein the configuration module further defines relationship between the pay code parameters using one or more formula sub-components, and wherein the one or more formula sub-components include at least one of priority, calculation function, mathematical operators, and parameter value.

10. The pay code configurator as claimed in claim 6, wherein the configuration module further associates the pay code calculation formula with the eligibility rule for configuring the pay code.

11. A non-transitory computer-readable medium having embodied thereon a computer program for executing a method of pay code configuration, the method comprising:
obtaining one or more pay code parameters and one or more eligibility parameters from an organization, wherein the eligibility parameters indicate eligibility criteria for an employee to be eligible for remunerations corresponding to a particular pay code as a part of the employee's net pay;
generating an eligibility rule based on the eligibility parameters for defining the eligibility criteria;
defining a pay code calculation formula based on the one or more pay code parameters for calculating the remuneration during payroll processing; and
mapping the eligibility rule and the pay code calculation formula to a payroll system of the organization for configuring the pay code.

12. The non-transitory computer-readable medium as claimed in claim 11, wherein the method further comprises determining, by the parameters determination module, sub-parameters corresponding to the one or more pay code parameters, wherein the sub-parameters include at least one of a parameter type, a parameter name, a query, a parameter value field type, and an LOV query.

13. The non-transitory computer-readable medium as claimed in claim 11, wherein the generating comprises determining, by the configuration module, values of one or more rule sub-components, and wherein the one or more rule sub-components include at least one of a pay code name, a pay code output, eligibility parameter, a mathematical operator, and a parameter value.

14. The non-transitory computer-readable medium as claimed in claim 11, wherein the defining comprises determining, by the configuration module, relationship between the pay code parameters using one or more formula sub-components, and wherein the one or more formula sub-components include at least one of a priority, a calculation function, a mathematical operator, and a parameter value.

15. The non-transitory computer-readable medium as claimed in claim 11, wherein the mapping further comprises associating, by the configuration module, the pay code calculation formula with the eligibility rule for configuring the pay code.
